(19) United States
(12) Patent Application Publication
(10) Pub. No.: US 2009/0088139 A1
(43) Pub. Date: Apr. 2, 2009

(54) Method, network unit and system for providing subscriber information of a group call to an interception unit

(75) Inventors: Martin Deubler, Gauting (DE); Johannes Gruenbauer, Krummennaab (DE); Demet Maras, Muenchen (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: NOKIA SIEMENS NETWORKS GMBH & CO. KG, MUNICH (DE)

(21) Appl. No.: 11/918,829

(22) PCT Filed: Apr. 18, 2006
(86) PCT No.: PCT/EP2006/003542

§ 371 Date: Dec. 10, 2008

(30) Foreign Application Priority Data
Apr. 18, 2005 (DE) 10 2005 017 806.5

(51) Int. Cl. H04M 3/42; H04L 27/06

(52) U.S. Cl. 455/414.3; 455/416; 370/259

(57) ABSTRACT

To provide at least one piece of subscriber information regarding at least one group call to an interception unit from a network unit by way of a communication network, the network unit receives at least one piece of subscriber information regarding at least one group call from a further network unit following a request for this at least one piece of subscriber information. The network unit forwards the at least one piece of subscriber information regarding the at least one group call in at least one IRI ticket to the interception unit.

The invention relates to a method, a network unit and a system for providing at least one piece of subscriber information regarding at least one group call to an interception unit (LEA) from a network unit (CSCF) by way of a communication network.

Service-dependent interception of users of a communication terminal device in the case of network operators (Telecommunication Service Providers, TSP) and Internet Service Providers (ISP) is an increasingly frequent requirement on the part of agencies. Terminal devices can be mobile radio terminals, fixed network terminals, stationary and mobile computers or the like. Services to be intercepted can for example be radio, television and multimedia services, multimedia broadcast services, multicast services, Voice over IP, Push to Talk services (group call) etc. It is known from the 3GPP specifications TS 33.107 and TS 33.108 relating to interception (monitoring) and TS 22.071 relating to LCS (Location Services) (see www.etsi.org) that during the interception of data (voice data/short message data/other data) relating to a mobile radio subscriber to be monitored in a mobile radio network by a (generally state-run) interception center, a switching facility (MSC or SGSN for example, by way of which data of the user of a terminal device to be monitored is transmitted), in addition to this data also transmits information providing further description of this communication such as location information relating to the current or last recorded location of the subscriber to the data center in an “IRI data set”. The location data transmitted in the interception-related information packet IRI or in the IRI information message represents the location information for example of the mobile radio subscriber in the form of cell information details (available to the switching facility or requested by the switching facility from a home register (HLR/HSS) of the mobile radio network) which indicate the cell or cell group in which the mobile radio subscriber was last registered. IRI information is generally typical signaling information, in other words for example who communicates with whom when, which services are utilized. Location information or location data can likewise be contained therein if use is made of corresponding services.

Lawful interception concepts are available and well-defined for voice applications or services in communication networks, for example cellular mobile radio networks, packet-switched communication networks, fixed networks, IP networks etc. It has not been possible thus far to intercept subscribers participating in a group call with the so-called “Push to Talk over Cellular” (PoC) function because the subscribers in the group call cannot be ascertained. “Push to Talk over Cellular” means that a subscriber establishes a connection with further subscribers in a previously defined group. When the connection has been established, voice communication is possible in such a manner that only one subscriber for example is able to speak whilst holding a key permanently depressed and the other subscribers in this group can only listen during this time. The group call or the PoC service is generally based on the use of an IP multimedia subsystem (3GPP TS 123 228 V5.7.0 (2002-12), Digital cellular telecommunications system (Phase 2+); Universal Mobile Telecommunications System (UMTS); IP Multimedia Subsystem (IMS); Stage 2 (3GPP TS 23.228 version 5.7.0 Release 5)). Furthermore, a so-called PoC unit is used for the service and a Group and List Management Server (GLMS) is used for managing the groups. For a group call with a group ID (group identity), the subscribers in the group call are stored and managed in this group and list management server. The address (one SIP URI, one TEL URI), the identity of the subscriber (an MSISDN identity) etc. for example are stored in this situation. The addresses are denoted in the IP multimedia subsystem as Public Service Identities (PSI). Such PSIs are standardized in the specification 3GPP TS 23.228, which defines both static PSIs and also dynamic PSIs. A PSI is represented by means of a URI (Uniform Resource Identifier). The group call using Push to Talk (PoC) is only one example from many of a group communication which is to be intercepted. Further forms of group communication can for example be instant messaging (“buddy lists”) or conferencing applications.

The object of the invention is to propose a simple and efficient solution for providing subscriber information regarding a group call to an interception unit.

The object is achieved according to the invention by the subject matter of the independent claims. Developments of the invention are set down in the subclaims.

A core feature of the invention consists in the fact that one network unit, for example a Call State Control Function (CSCF) of an IP multimedia subsystem, sends a request to a further network unit, for example a Group and List Management Server (GLMS). In general, for example a switching unit (MSC), a Serving GPRS Support Node (SGSN), Call State Control Function (CSCF) etc., with an IRI interface to an interception unit can be used as a network unit. According to the invention, it is also possible for the further network unit to be a presence server, a conference management unit, a group list management unit for a so-called “instant message” service or presence service. With regard to the request, it is a request to receive at least one piece of subscriber information regarding a group call. The subscriber list for the group call containing the subscriber identities (MSISDN), the SIP URIs, the TEL URIs etc. is used for example as the subscriber information. Naturally, it would also be possible to interrogate only the subscriber identities and/or the SIP URIs and/or the TEL URIs etc. of at least one subscriber. The request can be made for example using a SIP protocol, an H.323 protocol etc. and contains the group identity (Group ID) of the group call whose subscriber list or subscriber information is/are to be interrogated. According to the invention, the request is sent from the network unit to a PoC unit (Push to Talk over Cellular unit), to a presence server etc. and the PoC unit or the presence server forwards the request to the further network unit for further processing. The delivery of the subscriber information from the further network unit then takes place in the same manner by way of the PoC unit to the network unit. The further network unit could naturally encrypt the subscriber information before sending the subscriber information to the network unit in order that no misuse can occur.

One advantage of the method according to the invention consists in the fact that a high implementation overhead can be avoided in an extremely simple manner.

A further advantage consists in the fact that in the case of the described method the LI-IRI interfaces, in other words the interface from the network unit to the interception unit, is required only centrally (typically in the P-CSCF), whereas in the case of the prior art each further network unit must have an interface to the interception unit which has a high implementation overhead.

The invention will be described in detail with reference to an exemplary embodiment illustrated in a figure. In the drawings:

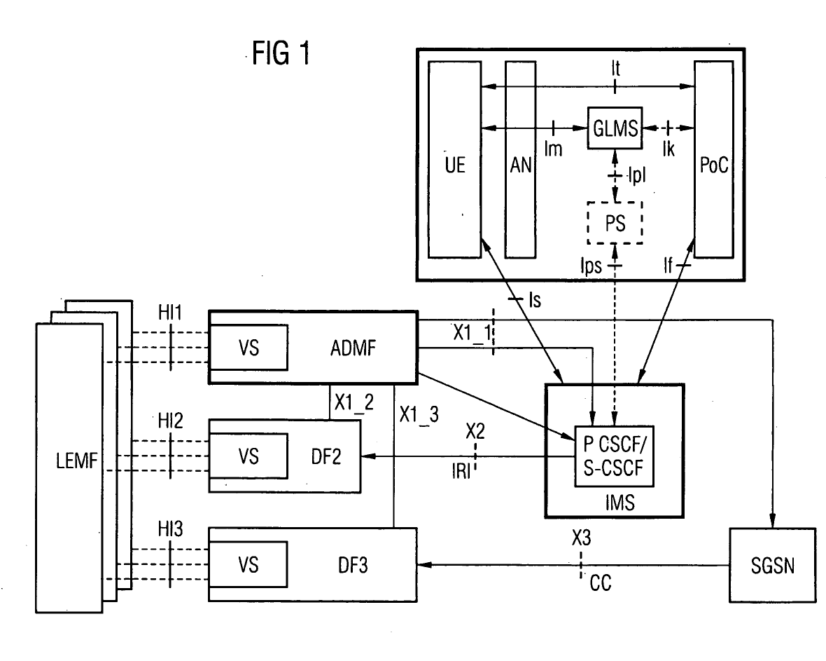

FIG. 1 shows a simplified network architecture for carrying out the method according to the invention, and

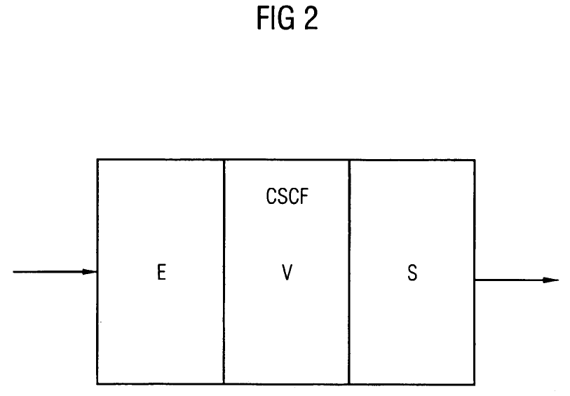

FIG. 2 shows a network unit according to the invention.

FIG. 1 shows a simplified network architecture for carrying out the method according to the invention. A terminal device UE establishes a so-called session (connection) with one or more further terminal devices UE. In this situation, the session is established inter alia by way of an access network AN to a communication network, a network unit CSCF, for example a Proxy Call State Control Function (P-CSCF) or a Serving Call State Control Function (S-CSCF) of an IP multimedia subsystem IMS and a PoC unit (PoC). After the session has been established voice communication is possible, whereby all subscribers can listen but only one of them can speak. A group call of this type is identified by a group identity (Group ID) and is managed in a Group and List Management Server (GLMS). In order to intercept one or more subscribers in the group call, a Law Enforcement Agency (LEA) with an interception unit (LEMF) applies for an intercept authorization from an empowered agency. An intercept authorization is communicated for example for a particular time, a particular call number etc. by way of an H1 line HI1 to a control center of a telecommunications or network operator (NWO=Network Operator, SvP=Service Provider). The H1 line is used for the administrative/communicative data traffic between the interception unit LEMF and network units of the communication network. On receipt of the intercept authorization, operators in the control center convert the interception destination data in order that the recording (IIF=Internal Interception Functions) of CC (interception data or content data) or IRI (Interception Related Information) is activated. Law enforcement agencies do not therefore have any direct access to the communication network. By way of a standardized interface INI (Internal Network Interface), the intercepted data CC or IRI data is conveyed using a delivery function DF2, DF3 to the interception unit LEMF. In this situation, a switching interface VS (mediation function device) is used for conveying the data or the IRI data to the interception unit LEMF. The intercepted data CC is sent by way of the H3 line HI3 and the IRI data by way of the H2 line HI2 to the interception unit LEMF using the delivery functions DF2 and DF3 respectively. In order to terminate the interception action, the interception unit LEMF notifies the Administration Function ADMF by way of the H1 line HI1 that the interception action is to be deactivated. The Call State Control Function CSCF is the central signaling node for switching services by way of rP signaling. To this end the CSCF utilizes the HSS database for accounting and authentication purposes. For communication purposes the CSCF uses as its signaling protocol the SIP protocol (Session Initiation Protocol) (a client/server protocol similar to HTTP, which for example can switch multimedia, telephone, conferencing connections). In the case of a group call with a group identity Group ID, a terminal device UE invites other members of the group call. During interception of such a group call, in addition to the information regarding the inviting terminal device UE the information as to which members the group call includes is also of interest to an interception unit LEMF. A group call is set up by the terminal device UE for example by means of a SIP signaling message (SIP INVITE message) by way of a PoC unit PoC which monitors and controls the group call. The PoC unit PoC identifies the terminal device UE and clarifies whether the terminal device is authorized to start a communication for the requested group call. If the terminal device is registered and the voice channels are not busy, the invitations (INVITE) are sent to the further members of the group call with their terminal devices. If the further members accept the invitation, the PoC unit PoC sends a so-called 200Ok message and informs the terminal device UE. The user of the terminal device UE, the suspect, and at the same time initiator of the group call receives a notification request (SIP NOTIFY) from each individual member of the group as a confirmation for the invitation message. This means that each member of the group call can be unambiguously identified because the notification message contains the MSISDN number. This information can be forwarded from the network unit CSCF in an IRI ticket to the interception unit LEMF. However, if a different member of the group call, in other words not the initiator of the group call, is to be intercepted, it is not possible to unambiguously determine which further group members the group call has. The method according to the invention can be applied in the case in this example. The network unit CSCF sends the Group and List Management Server GLMS a request by way of the PoC unit with the group identity of the group call whose subscriber list is to be interrogated. The SIP command “getmemberlist_groupID” can be used for this purpose, for example. As a response the network unit receives the subscriber list containing for example the MSISDN numbers of the subscribers and can send this list in at least one IRH ticket to the interception unit LEMF. Other subscriber information, such as for example the SIP URI address, the TEL URI address could likewise be contained in the list. The further network unit GLMS could interrogate a presence server PS for further data regarding subscribers in the group call and send this by way of the PoC unit to the network unit together with the subscriber list for the group call. It would naturally also be conceivable for the PoC unit to send the subscriber information received from the further network unit GLMS in at least one IRI ticket directly by way of the delivery functions DF3 and DF2 to the interception unit LEMF. This could also happen with interception data CC. With regard to the method according to the invention, the delivery to the network unit CSCF of the certificates for the interception, as is described in the standard, remains unaffected by the administration function ADMF. It is only necessary to ensure that the network unit CSCF and the further network unit GLMS are able to interpret and process or comprehend the certificates.

FIG. 2 shows a network unit CSCF according to the invention with a receive unit E, a send unit S and a processing unit V for carrying out the method according to FIG. 1.

1. A method for providing at least one piece of subscriber information regarding at least one group call to an interception unit (LEA) from a network unit by way of a communication network, comprising:
receiving at the network unit at least one piece of subscriber information regarding at least one group call from a further network unit following a request for this at least one piece of subscriber information; and
forwarding by the network unit the at least one piece of subscriber information regarding the at least one group call in at least one IRI ticket to the interception unit.

2. The method as claimed in claim 1,
wherein the request contains a group identity of the group call for which at least one piece of subscriber information is to be interrogated.

3. The method as claimed in claim 1, wherein
at least one of the SIP protocol and the H.323 protocol is used for signaling purposes for the request.

4. The method as claimed in claim 1, further comprising
sending by the network unit the request by way of at least one of a PoC unit and a presence server to the further network unit.

5. The method as claimed in claim 1, wherein
the network unit is at least one of a Call State Control Function, a switching unit and a Serving GPRS Support Node.

6. The method as claimed in claim 1, wherein
the network unit has an IRI interface to the interception unit.

7. The method as claimed in claim 1, wherein
the further network unit is at least one of a Group and List Management Server, a conference management unit, a group list management unit for an “instant message” service and a presence server.

8. The method as claimed in claim 1, further comprising
using at least one of a subscriber identification number, a SIP URI and a TEL URI as subscriber information.

9. The method as claimed in claim 1, wherein
the subscriber information is a subscriber list for the group call.

10. The method as claimed in claim 9, wherein
the subscriber list contains at least one of a subscriber identity, a SIP URI and a TEL URI.

11. The method as claimed in claim 1, wherein
the communication network includes at least one of a cellular mobile radio network, a packet-switched communication network, a fixed network and an IP network.

12. A network unit for providing at least one piece of subscriber information regarding at least one group call to an interception unit, comprising:
a receive unit and a send unit for carrying out a communication, and
a processing unit for receiving from a further network unit at least one piece of subscriber information regarding the at least one group call following a request for this at least one piece of subscriber information and for forwarding the received at least one piece of subscriber information regarding the at least one group call in at least one IRI ticket to the interception unit.

13. A system for providing at least one piece of subscriber information regarding at least one group call to an interception unit from a network unit by way of a communication network, comprising:
a network unit for receiving from a further network unit at least one piece of subscriber information regarding the at least one group call following a request for this at least one piece of subscriber information and for forwarding the received at least one piece of subscriber information regarding the at least one group call in at least one IRI ticket to the interception unit,
a further network unit for providing and sending the requested subscriber information regarding the at least one group call, and
an interception unit for evaluating the at least one piece of subscriber information in the IRI ticket.
